(19) United States
(12) Patent Application Publication
(10) Pub. No.: US 2003/0123554 A1
(43) Pub. Date: Jul. 3, 2003

(54) Video decoding system

(76) Inventors: Eung Tae Kim, Jangan-gu (KR); Seung Jong Choi, Seoul (KR)

Correspondence Address: HARNESS, DICKEY & PIERCE, P.L.C., P.O. BOX 8910, RESTON, VA, 20195, US

(21) Appl. No.: 10/329,700

(22) Filed: Dec. 27, 2002

(30) Foreign Application Priority Data
Dec. 29, 2001 (KR) P 2001-87768

(51) Int. Cl. H04N 7/12

(52) U.S. Cl. 375/240.25; 375/240.16

(57) ABSTRACT

An MPEG-2 video decoding system is disclosed, which is applied to a digital TV or a digital video conference. In the present invention, ‘I’ or ‘P’ as a reference frame is reduced in a horizontal direction at 1/2, and then is stored in an external memory. Meanwhile, in a case of ‘B’ picture which is not used as a reference frame, ‘B’ picture is reduced in both horizontal and vertical directions by 1/2, so that ‘B’ picture is reduced at 3/4, and then is stored in the external memory. Accordingly, it is possible to reduce memory at 50% to 62.5% and to maintain a good picture quality in the present invention. Also, field information of the vertical direction is maintained, thereby decreasing drift errors during decoding MPEG video.

This application claims the benefit of Korean Application No. P2001-87768, filed on Dec. 29, 2001, which is hereby incorporated by reference as if fully set forth herein.

### BACKGROUND OF THE INVENTION

1. Field of the Invention

The present invention relates to a video decoding system for reducing an external memory of a Moving Picture Experts Group (MPEG)-2 video decoding system for a digital TV or a digital video conference system.

2. Description of the Related Art

In general, an MPEG-2 video decoding system is provided with a TP (Transport Packet)-decoder, a video decoder, a video display processor, an external memory, a host interface and the like. The external memory may be a DRAM (or S DRAM) for storing a bit stream and frames for motion compensation. Especially, the external memory of a video decoder is used for write/read of the bit stream for video-decoding, read of data demanded on the motion compensation, write of the decoded data and read of the displayed data. The data is received and transmitted through a memory interface.

At this time, it is required to increase the size of a memory and a data transmitting speed so as to decode video data of MP@HL in MPEG-2 standard mode. That is, MPEG-2 standard requires a bit buffer size of 10 Mbits for supporting an MP@HL mode, at a maximum allowable bit rate of 80 Mbit/s. An existing 16 Mbits DRAM basis MPEG-2 decoder requires an external memory of approx. 96˜128 Mbits size. Therefore, price competitiveness is required in manufacturers and consumers. In order to get the price competitiveness, a picture quality should be well maintained while reducing the use of expensive memory. However, it is inevitable that use of additional external memories is increased in the future in light of a trend that various functions including an OSD (On Screen Display) and a variety of services are provided.

For instance, in case of a video compression and decoding system such as MPEG-2, a variety of video signals are multi-decoded and displayed, for providing a variety of services, when it is required that the variety of video signals are decoded by using a limited capacity of the memory. At the end, considering a limitation in the memory size, a price, and a bandwidth of a data bus, the video decoding device is required to additionally equip an effective device for reducing a memory capacity that can minimize a loss of a high-quality picture signal.

In memory reduction algorithms loaded on existing video decoding systems, there are the ADPCM (Adaptive Differential Pulse Coded Modulation) type with a 50% reduction ratio, and the type with 75% reduction ratio that eliminates spatial duplicity by using VQ (Vector Quantization). Also, a compression method of down conversion algorithms in DCT frequency domain of the video decoding chips is suggested. Because a compressed code is stored in the memory, the ADPCM method is difficult to display a video by using display right away, to require a device for decoding the compressed code, additionally. Since the ADPCM method shows very great picture quality loss in a case of 75% reduction, the ADPCM method is not suitable for the video decoding chip.

Currently, in this state spread of HD displays are not enough, there are many cases when an HD class picture quality video sequence is displayed in a lower resolution through TV receivers of present NTSC (National Television System Committee) standards. Therefore, it is required that users can watch an HDTV broadcasting signal through the NTSC TV receivers without buying expensive HDTV (High Definition Television), immediately. As explained above, a device for converting the HDTV broadcasting signal suitable to the NTSC TV receiver is called as a down converting decoder. At the end, by employing the down converting decoder, a TV receiver having a price significantly lower than a TV receiver having a perfect HD class resolution can be obtained.

This method can maintain a good picture quality to some extent despite of substantial reduction of the memory capacity, and applicable to inexpensive decoders for a low-resolution display. Therefore, a down conversion algorithm that allows to employ a small capacity memory while a good picture quality can be maintained and a hardware design for the down conversion algorithm are required.

One of these methods is down conversion method in a frequency domain. One of these types is a down sampler for removing 48 high frequency DCT coefficients in 8×8 blocks. An output result of IDCT for the rest low frequency 4×4 blocks is stored in an external memory. On making motion compensation, a 1/4 pel motion compensation is performed using a corresponding motion vector in 1/2 reduced resolution area in vertical and horizontal directions. However, this method causes to occur drift errors and block artifact due to loss of high frequency data. To overcome problems of the drift errors, for making accurate motion compensation, when it is intended to reduce an error of motion compensation prediction by using perfect resolution motion vectors, a frame of reduced resolution is used as reference. At the end, in order to provide a picture of a perfect resolution from a picture of a reduced resolution, an up-sampling method is employed.

A few effective methods are suggested for reducing the errors of motion compensation prediction by up-sampling a picture down sampled by using 4×4 IDCT. These methods employ tow dimensional filters, each having 5 taps or 8 taps depending on a typically predicted motion vector of a macro block, when positions of 8 tap filter values are changed depending on the motion vector, to require an increase from 4 pels to 8 pels by one 8 tap filter.

However, the existing video decoder reads pixels by frame unit or field unit from the memory according to frame picture or field picture, so that the aforementioned method results in unfavorable influence of prediction error accumulation in making motion compensation in an area having a great motion. On down sampling in the vertical direction for 75% reduction, the results of the down-sampled frame picture and field picture are different to each other. Accordingly, information on a field is lost when the motion compensation is made or the video data in an interlaced scanning type is displayed in field units.

Therefore, picture quality deterioration generates since the motion compensation is performed in the area having the great motion by the field units. In case of an interlaced sequence relating to the field unit, high frequency components of the vertical direction are lost in frame units, thereby generating a serious field mismatch or a flickering on a screen. That is, an area corresponding to a low frequency band is used among 8×8 DCT coefficient (which is referenced as 4×4 cut). Eventually, the interlaced sequence processed at an MPEG-2 video decoder has a problem of loss of high frequency band signals between the fields.

### SUMMARY OF THE INVENTION

Accordingly, the present invention is directed to a video decoding system that substantially obviates one or more problems due to limitations and disadvantages of the prior art.

An object of the present invention is to provide to a video decoding system for improving a picture quality, while maintaining field information in a vertical direction, by reducing memory capacity in different fashion according to the type of a picture.

Another object of the present invention is to provide to a video decoding system using a down conversion method storing an anchor frame being reduced by 1/2, and storing ‘B’ frame being reduced by 1/4, the ‘B’ frame which is not used as a reference frame, thereby improving a picture quality.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a video decoding system includes a VLD performing variable length decoding (VLD) of a compressed video bit stream; an IQ inversely quantizing a DCT coefficient from the VLD; an IDCT performing Inverse Discrete Cosine Transform (IDCT) of the inversely quantized DCT coefficient; an adder adding data from the IDCT to motion compensated data, thereby restoring the result to a pixel value of an original image; a down sampler resolution-reducing the data output from the adder in a horizontal direction or in a vertical direction according to the type of a picture of the data output from the adder; an external memory storing the down-sampled picture data from the down-sampler; an up-sampler performing up-sampling of the reference picture output from the external memory in the horizontal direction, and a motion compensator performing a motion compensation of the up-sampled picture in the horizontal direction from the up-sampler with the motion vector of full resolution from the VLD.

Preferably, the down sampler reduces a resolution of data output from the adder by 1/2 in a horizontal direction if the data output from the adder is ‘I’ picture or ‘P’ picture, and the down sampler reduces a resolution of data in both horizontal and vertical directions by 1/2 if the data output from the adder is ‘B’ picture.

Preferably, the down sampler converts a frame picture to a field structure during performing down sampling while performing down sampling to convert bottom and top fields, respectively.

Preferably, the down-sampler divides signals into luminance and chrominance signals during down-sampling in the vertical direction.

Preferably, the up-sampler performs twice up-sampling of the reference picture data being read from the external memory in the horizontal direction.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 is a block diagram illustrating a vide decoding system according to the present invention;

FIG. 2 is a detailed block diagram of FIG. 1;

FIG. 3 is a block diagram illustrating a down-sampler of FIG. 1 according to another embodiment of the present invention;

FIG. 4A to FIG. 4D are exemplary views illustrating each memory when using 3-frame capacity as an external memory capacity;

FIG. 5A to FIG. 5D are exemplary views illustrating each memory when using 4-frame capacity as an external memory capacity; and

FIG. 6 is a detailed block diagram illustrating a motion compensator of FIG. 1.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

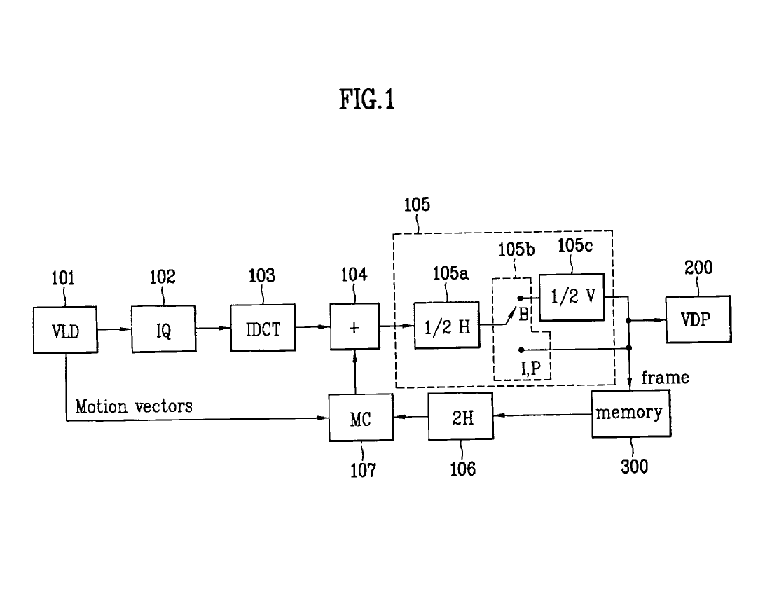

FIG. 1 is a block diagram illustrating a video decoding system according to the present invention. Referring to FIG. 1, the video decoding system according to the present invention includes a VLD (Variable Length Decoder) 101, an IQ (Inverse Quantizer) 102, an IDCT (Inverse Discrete Cosine Transformer) 103, an adder 104, a down-sampler 105, an up-sampler 106 and an MC (Motion Compensator) 107.

At this time, the VLD 101 performs variable length decoding (VLD) of a compressed video bit stream, so that the compressed video bit stream is divided into a motion vector, a quantized coefficient and a DCT (Discrete Cosine Transform) coefficient. The IQ 102 inversely quantizes the DCT coefficient output from the VLD 101 and the IDCT 103 performs Inverse Discrete Cosine Transform (IDCT) of the inversely quantized DCT coefficient. Then, the adder 104 adds data output from the IDCT 103 to motion compensated data. The down sampler 105 outputs data to a VDP (Video Display Processor) 200 so as to be reduced and displayed in a vertical or horizontal directions at a predetermined reduction ratio according to a picture type output from the adder 104, simultaneously, outputs data to an external frame memory 300 for a motion compensation. The up-sampler 106 reads the data stored in the external frame memory 300, while performing up-sampling of the data in the horizontal direction. The MC 107 compensates a motion with output of the up-sampler 106 and the motion vector output from the VLD 101, and then outputs the result to the adder 104.

The down sampler 105 includes a horizontal reduction part 105a, a switching part 105b and a vertical reduction part 105c. At this time, the horizontal reduction part 105a reduces the output from the adder 105 by 1/2 reduction ratio in the horizontal direction. The switching part 105b is switched according to a result whether a picture of an output signal from the horizontal reduction part 105a is ‘B’ picture. The vertical reduction part 105c reduces ‘B’ picture being output from the switching part 105b by 1/2 reduction ratio in the vertical direction. In this case, ‘I’ and ‘P’ pictures are bypassed to the VDP 200 and the external frame memory 300 through the switching part 105b.

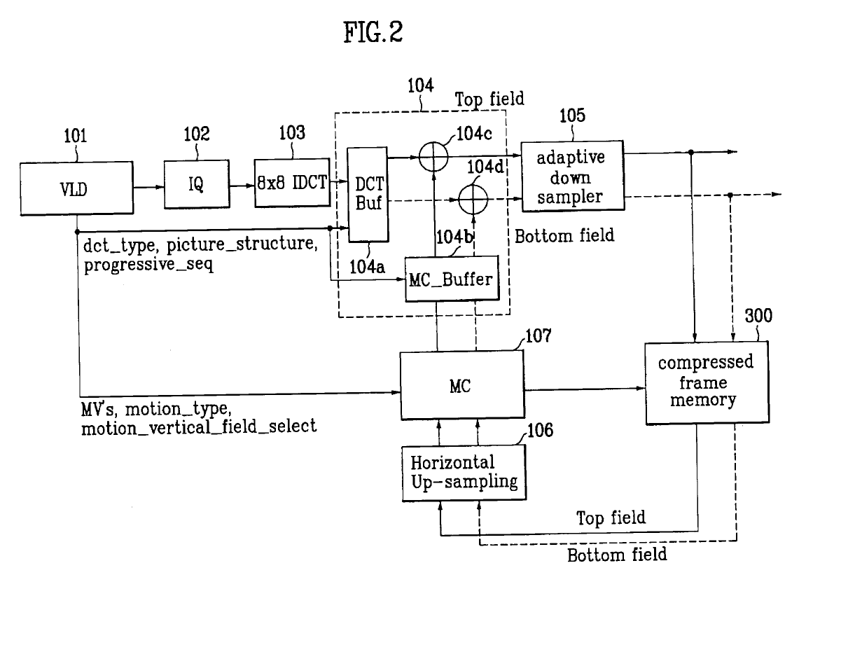

FIG. 2 is a detailed block diagram of FIG. 1. Referring to FIG. 2, a signal path of the adder 104 is divided into bottom and top fields. In this respect, the adder 104 includes a DCT buffer 104a, an MC buffer 104b and adders 104c and 104d. The DCT buffer 104a temporarily stores the data output from the IDCT, divides the data into the bottom and top fields, and then outputs the data being divided into the bottom and top fields. The MC buffer 104b temporarily stores data of the bottom and top fields, being motion-compensated. The adder 104c adds a DCT coefficient of the top field output from the DCT buffer 104a to data of the top field output from the MC buffer 104b, and another adder 104d adds a DCT coefficient of the bottom field output from the DCT buffer 104a to data of the bottom field output from the MC buffer 104b.

In the video decoder according to the present invention, the compressed video bit stream is output to the VLD 101, so that the compressed video bit stream is divided into the motion vector (MV), the quantized coefficient and the DCT (Discrete Cosine Transform) coefficient. Then, MV (motion vector), motion_type and motion_vertical_field-select signals are output to the motion compensator (MC) 107, and the quantized coefficient and DCT coefficient are output to the Inverse Quantizer (IQ) 102. Also, dct-type (frame or field), picture-structure (frame picture or field picture) and progressive_seq (progressive sequence) signals from the VLD 101 are output to the DCT buffer 104a and MC buffer 104b of the adder 104 for being divided into the bottom and top fields. At this time, since the DCT coefficient is coated in a zig-zag scan method or an alternate scan method, the IQ 102 inversely scans the DCT coefficient in Raster Scan method, inversely quantizes the inversely scanned DCT coefficient according to the quantized coefficient and then outputs the inversely quantized DCT coefficient to the IDCT 103. The IDCT 103 performs IDCT to the inversely quantized IDCT coefficient by 8×8 block units according to an MPEG-2 video syntax, and then the result is output to the adder 104.

The DCT buffer 104a of the adder 104 divides the data output from the IDCT into the bottom and top fields according to the dct-type (frame or field), the picture-structure (frame picture or field picture), and progressive-sequence information. At this time, the MC buffer 104b stores the motion compensated data in the MC 107 according to the picture-structure as the frame or field structure. The adder 104c adds the top field of the data output from the IDCT to the top field of the motion compensated data in the MC buffer 104b and then outputs the result to the down sampler 105. Another adder 104d adds the bottom field of the data output from the IDCT to the bottom field of the motion compensated data in the MC buffer 104b and then outputs the result to the down sampler 105. The down sampler 105 respectively performs down sampling of the top field and the bottom field. That is, the down sampler 105 reduces each field signal from the adder by 1/2 reduction ratio or 3/4 reduction ratio according to the picture type, thereby reducing an original signal.

More specifically, the horizontal reduction part 105a of the down sampler 105 reduces a resolution to the output of the adder 104 at 1/2 reduction ratio in the horizontal direction by 8*8 block units. If the reduced signal is ‘B’ picture, the signal is output to the vertical reduction part 105c through the switching part 105b. Therefore, the vertical reduction part 105c reduces the resolution of ‘B’ picture having the 1/2 resolution reduction ratio in the horizontal direction by 1/2 reduction ratio in the vertical direction, thereby outputting ‘B’ picture having the 1/2 resolution reduction ratio in both the horizontal and vertical directions to the VDP 200 and the external frame memory 300. Accordingly, in a case of ‘B’ picture, the original signal is reduced by 3/4. Meanwhile, the reduced signal is ‘I’ or ‘P’ picture, the signal is output to the VDP 200 and the external frame memory 300 through the switching part 105b. That is, ‘I’ or ‘P’ picture, reference picture, is resolution-reduced at 1/2 reduction ratio in the horizontal direction in a state of maintaining field information and then is output to the external frame memory 300.

However, in a case of ‘B’ picture, the resolution is reduced at 1/2 reduction ratio in the horizontal and vertical directions after changing the frame picture to the field structure without any influence whether a DCT block of a received video sequence is a field DCT coded block or a frame DCT coded block. Then, ‘B’ picture being resolution-reduced by 1/2 reduction ratio in the horizontal and vertical directions is output to the external frame memory 300. That is, in a case of the frame DCT coded block, the frame DCT coded block is divided into the signals of the field unit, and frequency components in 8×8 block unit are extracted, and are down-sampled in a frequency domain.

For instance, in 75% reduction of ‘B’ picture, it is required to separately process a luminance signal and a chrominance signal in the original data so as to maintain information for fields in the external frame memory. In case of the frame picture, the chrominance signal is divided into 4×8 sized bottom and top fields. Contrary to the chrominance signal, the luminance signal is divided into 8×8 sized bottom and top fields. Accordingly, it is possible to prevent the field information from being lost in case of ‘B’ picture, thereby maintaining a good picture quality.

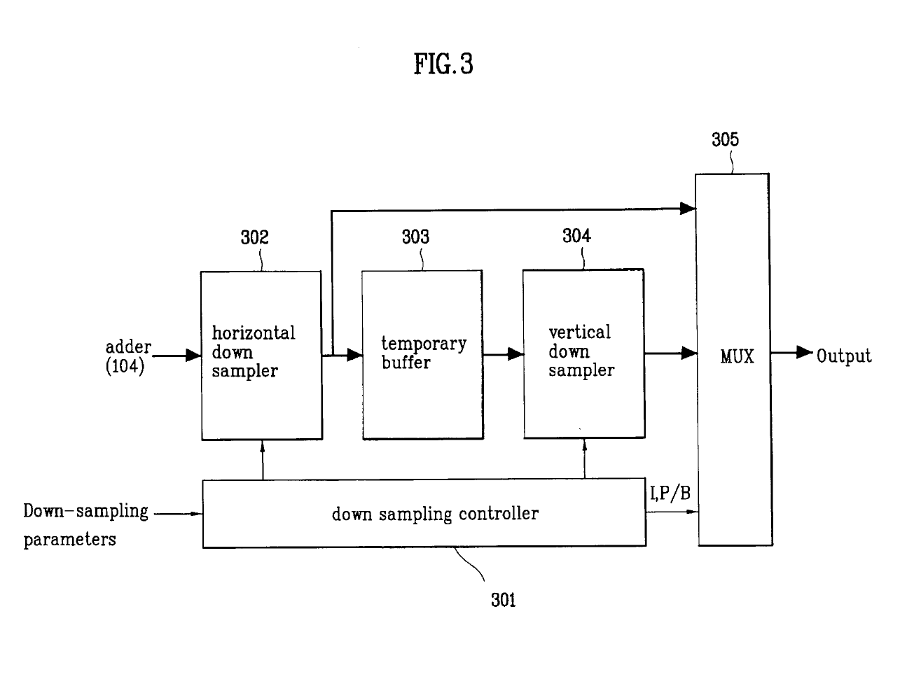

FIG. 3 is a block diagram illustrating a down-sampler of FIG. 1 according to another embodiment of the present invention. Referring to FIG. 3, the down-sampler according to another embodiment of the present invention includes a down-sampling controller 301, a horizontal down sampler 302, a temporary buffer 303, a vertical down sampler 304 and a MUX 305.

A signal output from the adder 105 is resolution-reduced at 1/2 ratio by a horizontal direction in the horizontal down sampler 302 under control of the down-sampling controller 301, and then is simultaneously output to the temporary buffer 303 and the MUX 305. The temporary buffer 303 outputs the data being resolution-reduced at 1/2 reduction ratio in the horizontal direction to the vertical down sampler 304. Then, the vertical down sampler 304 reduces resolution of the data at 1/2 reduction ratio in a vertical direction, and outputs the data to the MUX 305.

At this time, a process for down-sampling is separately performed to a luminance signal and a chrominance signal in the vertical down sampler 304. In case of a frame picture, the chrominance signal is divided into 4×8 sized bottom and top fields. In case of the chrominance signal, the luminance signal is divided into 8×8 sized bottom and top fields. Accordingly, it is possible to prevent field information from being lost in case of ‘B’ picture. Then, the MUX 305 selects the output of the horizontal down sampler 302 according to a picture type in a case of ‘I’ or ‘P’ picture, and then outputs the selected output to the VDP 200 and the external frame memory 300. In case of ‘B’ picture, the MUX selects the output of the vertical down sampler 304 and then outputs the selected output to the VDP 200 and the external frame memory 300.

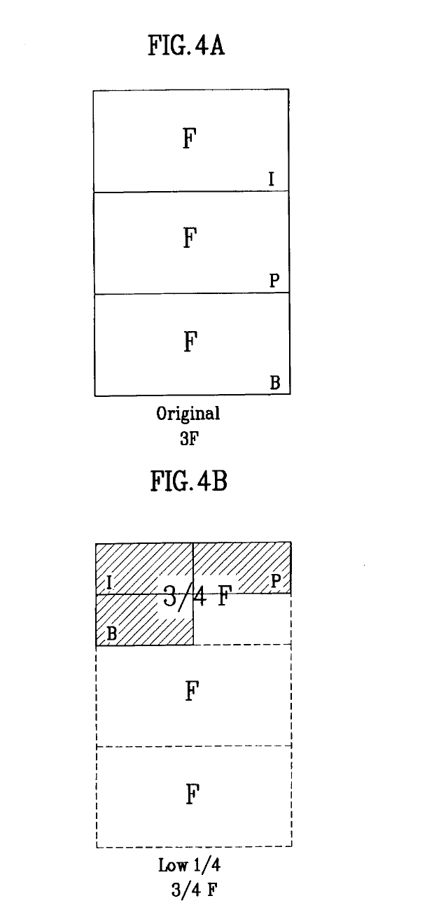

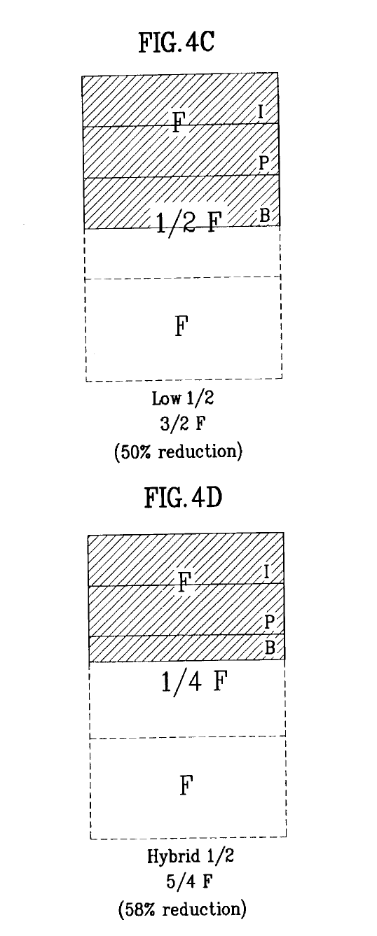

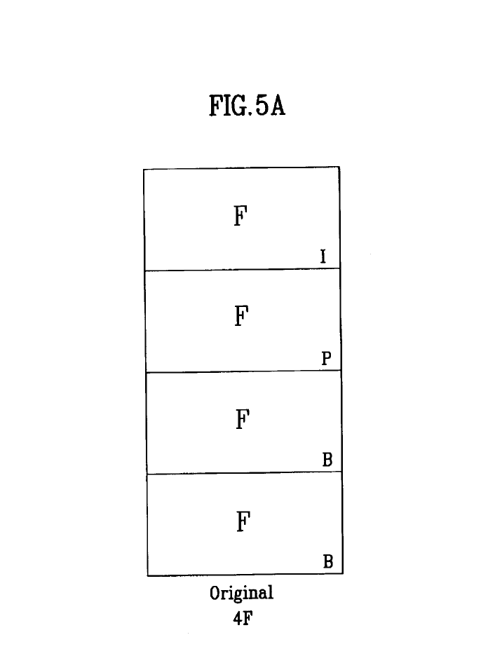

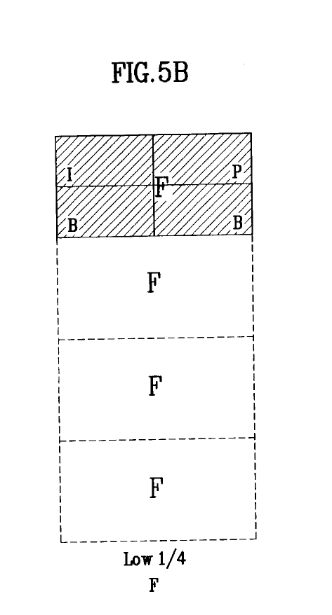

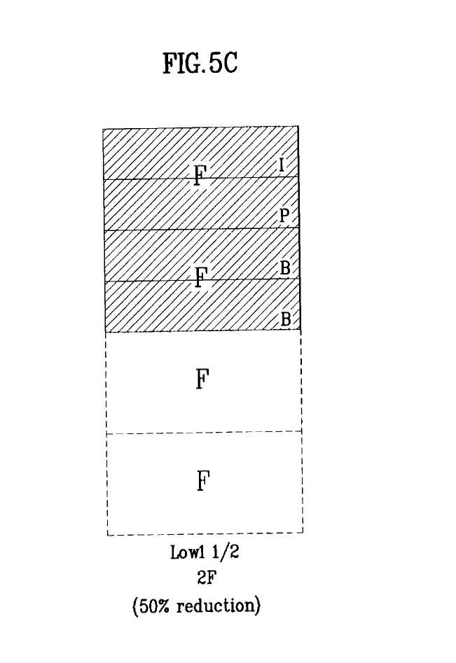

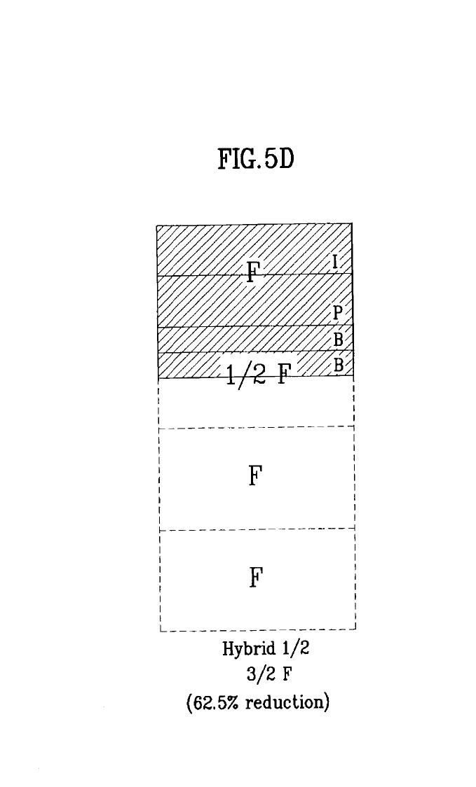

FIG. 4A to FIG. 4D are exemplary views illustrating each memory when using 3-frame capacity as an external memory capacity. FIG. 5A to FIG. 5D are exemplary views illustrating each memory when using 4-frame capacity as an external memory capacity.

FIG. 4A shows a case in which a video decoder requires at least three frames so as to decode a MPEG sequence. At this time, one frame is an existing frame, and other two frames are anchor reference frames. FIG. 4B shows a down conversion method reducing resolution by 1/2 ratio in horizontal and vertical directions respectively. In this case, a memory is reduced at 75% ratio. However, field information or high frequency may be lost in the vertical direction, thereby deteriorating a picture quality. FIG. 4C shows a down conversion method reducing resolution by 1/2 ratio in the horizontal direction. At this time, a memory is reduced at 50% ratio. That is, field information of the vertical direction is maintained, but high frequency of the vertical direction is lost. FIG. 4D shows a down conversion method according to the present invention, in which the reference frame of ‘I’ or ‘P’ picture is reduced at 1/2 ratio in the horizontal direction, and ‘B’ picture is reduced at 1/2 ratio in the vertical and horizontal directions, thereby obtaining 58% reduction ratio in the memory. In this state, ‘B’ picture has no influence to other pictures, thereby preventing drift errors from being accumulated. Also, the VDP 200 has scaling function, so that it is possible to easily decrease or increase video. The present invention shown in FIG. 4C can be easily fabricated.

FIG. 5A to FIG. 5D are exemplary views illustrating each memory when using 4-frame capacity as an external memory capacity, which is required for a special display processor or a video decoding freeze. In the memory using 3-frame capacity as an external memory capacity, a tearing problem may occur due to a delay between a decoding time and a display time, so that a memory of 4-frame capacity is used as an external memory capacity as shown in FIG. 5A to FIG. 5D. FIG. 5B and FIG. 5C uses a down conversion method for reducing a memory which is used in FIG. 4B and FIG. 4C. The structure of FIG. 5D according to the present invention has greater memory reduction ratio as compared with a related art structure. That is, the memory of 3-frame capacity shown in FIG. 4D is reduced at 58% ratio, but the memory of 4-frame capacity shown in FIG. 5D is reduced up to 62.5% ratio.

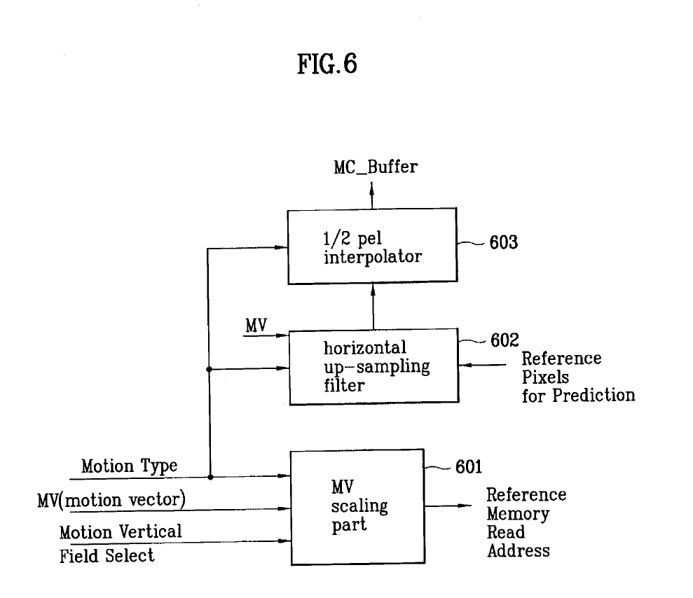

FIG. 6 is a detailed block diagram illustrating an up-sampler reading the data down-sampled and stored in the external memory, and a motion compensator performing motion compensation of the data. In a case of ‘I’ picture, the data output from IQ/IDCT is performed in the down sampler 105, and then is stored in the external frame memory 300. However, in case of ‘P’ picture or ‘B’ picture, the data output from IQ/IDCT is added to the motion prediction compensated blocks in the adder 104 which then is performed in the down sampler 105, thereby storing the result in the external frame memory 300. At this time, the video encoder uses a motion vector of full resolution so as to obtain motion compensated frame, thereby restoring a block of an existing frame from the prior frame.

Accordingly, the present invention of FIG. 6 uses the motion vector of full resolution instead of a scaling down method of a motion vector in a horizontal direction. In this case, it is required to up-sample a resolution-reduced reference picture to an original resolution in a horizontal up-sampling filter 602 of the up-sampler 106. For this, a MV scaling part 601 receives motion-type, motion vector and field select signals from the VLD 101, and generates a lead address of the external frame memory 300. The horizontal up-sampling filter 602 reads reference pixels corresponding to the lead address from the external frame memory 300, performs twice up-sampling to the reference pixels in the horizontal direction, and outputs the result to a half-pel interpolator 603.

The half-pel interpolator 603 is a motion compensator, which performs half-pel interpolation to the up-sampled block, so that the motion compensated block is composed and output to the MC buffer 104b of the adder 104. At this time, since ‘B’ picture is not used as the reference picture, a vertical direction up-sampling is not performed in the up-sampler. That is, in the related art method for reducing memory by 75% ratio, each field is up-sampled in the horizontal and vertical directions on a frame prediction mode, and it is required to make a macro block into frame units. However, in the present invention, up-sampling is performed in the horizontal direction, thereby easily performing the motion compensation. Accordingly, in the memory reduction method according to the present invention, various memory capacities are used according to the picture type, thereby easily reducing the memory at 50% or more.

As mentioned above, the video decoding system according to the present invention has the following advantages.

In the present invention, ‘I’ or ‘P’ picture as the reference frame is reduced by 1/2 ratio in the horizontal direction, and then is stored in the external memory. In a case of ‘B’ picture which is not used as the reference frame, ‘B’ picture is reduced by 1/2 ratio in the horizontal and vertical directions respectively, so that ‘B’ picture is totally reduced by 3/4 ratio. Accordingly, the present invention is very effective in storing a variety of video signals and to decrease the memory capacity or bandwidth. Also, the field information is maintained in the vertical direction, which makes it is possible to decrease drift errors during decoding the MPEG video, thereby maintaining a good picture quality. That is, the memory is reduced at a ratio between 50% and 62.5% in a state of maintaining the good picture quality.

The present invention is necessary for the digital TV or video conference system, which has price competitiveness by reducing the memory, and provides a variety of services in a limited capacity of memory, thereby increasing competitiveness of the digital TV or video conference system using the present invention.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A video decoding system comprising:
a VLD performing variable length decoding (VLD) of a compressed video bit stream;
an IQ inversely quantizing a DCT coefficient output from the VLD;
an IDCT performing Inverse Discrete Cosine Transform (IDCT) to the inversely quantized DCT coefficient;
an adder adding data from the IDCT to motion compensated data, thereby restoring the result to a pixel value of an original image;
a down sampler resolution-reducing the data output from the adder in a horizontal direction or in both horizontal and vertical directions according to a picture type of the data output from the adder;
an external memory storing the down-sampled picture data in the down-sampler; and
a motion compensator performing motion compensation of a reference picture output from the external memory with a motion vector from the VLD and outputting the result to the adder.

2. The video decoding system of claim 1, further comprising an up-sampler performing up-sampling of the reference picture output from the external memory in a horizontal direction, wherein the motion compensator performs motion compensation of the up-sampled picture in the horizontal direction output from the up-sampler with the motion vector of full resolution from the VLD.

3. The video decoding system of claim 1, wherein the down sampler reduces data from the adder in a horizontal direction if the data from the adder is ‘I’ picture or ‘P’ picture, and the down sampler reduces the data in both horizontal and vertical directions if the data from the adder is ‘B’ picture.

4. The video decoding system of claim 1, wherein the down sampler reduces resolution of data output from the adder by 1/2 in a horizontal direction if the data from the adder is ‘I’ picture or ‘P’ picture, and the down sampler reduces resolution of the data in both horizontal and vertical directions by 1/2 if the data from the adder is ‘B’ picture.

5. The video decoding system of claim 1, wherein the down sampler respectively performs down sampling to bottom and top fields during performing down-sampling in the vertical direction.

6. The video decoding system of claim 1, wherein the down sampler converts a frame picture to a field structure during performing down sampling in the vertical direction, and then respectively performs down sampling to converted bottom and top fields.

7. The video decoding system of claim 1, wherein signals are divided into luminance and chrominance signals during down-sampling in the vertical direction, at this time, in a case of frame picture, the chrominance signal is divided into 4×8 sized bottom and top fields, and the luminance signal is divided into 8×8 sized bottom and top fields.

8. The video decoding system of claim 1, wherein the down sampler includes;
a horizontal reduction part performing down-sampling to output of the adder by 1/2 ratio in the horizontal direction,
a switching part bypassing the output of the horizontal reduction part to the external memory in a case of that the horizontally reduced data is ‘I’ picture or ‘P’ picture, and
a vertical reduction part performing down-sampling of ‘B’ picture being output from the switching part by 1/2 reduction ratio in the vertical direction and outputting the result to the external memory.

9. The video decoding system of claim 1, wherein the down sampler includes;
a horizontal down sampler performing down-sampling of output data from the adder by 1/2 ratio in the horizontal direction,
a vertical down sampler performing down-sampling of output data of the horizontal down sampler by 1/2 reduction ratio in the vertical direction, and
a selection part selecting output from the horizontal down sampler in a case that the down-sampled data is ‘I’ picture or ‘P’ picture so as to output the result to the external memory, and selecting output from the vertical down sampler in a case of that the down-sampled data is ‘B’ picture so as to output the result to the external memory.

10. The video decoding system of claim 2, wherein the up-sampler performs twice up-sampling to the reference picture data being read from the external memory in the horizontal direction.

11. The video decoding system of claim 10, wherein the motion compensator performs half-pel interpolation of the up-sampled block, thereby generating a motion compensated block.

12. The video decoding system of claim 10, wherein the up-sampler reads ‘I’ picture or ‘P’ as the reference picture, the ‘I’ or ‘P’ picture being reduced in the horizontal direction and being stored in the external memory.

13. A video decoding system comprising:
a VLD performing variable length decoding (VLD) of a compressed video bit stream;
an IQ inversely quantizing a DCT coefficient from the VLD;
an IDCT performing Inverse Discrete Cosine Transform (IDCT) of the inversely quantized DCT coefficient;
an adder adding data from the IDCT to motion compensated data, thereby restoring the result to a pixel value of an original image;
a down sampler reducing data from the adder in a horizontal direction if the data from the adder is ‘I’ picture or ‘P’ picture and reducing the data in both horizontal and vertical directions if the data from the adder is ‘B’ picture;
an external memory storing the down-sampled picture data from the down-sampler;
an up-sampler performing up-sampling of the reference picture, ‘I’ or ‘P’ picture, from the external memory in a horizontal direction; and
a motion compensator performing motion compensation of the up-sampled picture in the horizontal direction from the up-sampler with the motion vector of full resolution from the VLD and outputting the result to the adder.

14. The video decoding system of claim 13, wherein the down sampler reduces resolution of data output from the adder by 1/2 in the horizontal direction if the data from the adder is ‘I’ picture or ‘P’ picture, and the down sampler reduces resolution of the data in both horizontal and vertical directions by 1/2 if the data from the adder is ‘B’ picture.

15. The video decoding system of claim 13, wherein the down sampler respectively performs down sampling to bottom and top fields while performing down-sampling in the vertical direction, and the down sampler converts a frame picture to a field structure while performing down sampling, then separately performs down sampling to converted bottom and top fields.

16. The video decoding system of claim 13, wherein signals are divided into luminance and chrominance signals during down-sampling in the vertical direction, at this time, in a case of frame picture, the chrominance signal is divided into 4×8 sized bottom and top fields, while performing the luminance signal is divided into 8×8 sized bottom and top fields.

17. The video decoding system of claim 13, wherein the down sampler includes;
a horizontal reduction part performing down-sampling of output of the adder by 1/2 reduction ratio in the horizontal direction,
a switching part bypassing the output of the horizontal reduction part to the external memory in a case that the horizontally reduced data is ‘I’ picture or ‘P’ picture, and
a vertical reduction part performing down-sampling of ‘B’ picture being output from the switching part by 1/2 reduction ratio in the vertical direction and outputting the result to the external memory.

18. The video decoding system of claim 13, wherein the down sampler includes;
a horizontal down sampler performing down-sampling of output data of the adder by 1/2 ratio in the horizontal direction,
a vertical down sampler performing down-sampling of output data of the horizontal down sampler by 1/2 ratio in the vertical direction, and
a selection part selecting output from the horizontal down sampler in a case that the down-sampled data is ‘I’ picture or ‘P’ picture so as to output the result to the external memory, and selecting output from the vertical down sampler in a case that the down-sampled data is ‘B’ picture so as to output the result to the external memory.

19. The video decoding system of claim 13, wherein the up-sampler performs twice up-sampling to the reference picture data being read from the external memory in the horizontal direction.

20. The video decoding system of claim 13, wherein the motion compensator performs half-pel interpolation to the up-sampled block, thereby generating a motion compensated block.
